(19) United States
(12) Patent Application Publication
(10) Pub. No.: US 2026/0163063 A1
(43) Pub. Date: Jun. 11, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Yeon A KIM, Suwon-si (KR); Sang Hoon KIM, Suwon-si (KR); E Rang CHO, Suwon-si (KR); Bo Mee KWON, Suwon-si (KR); Eui Soo JEONG, Suwon-si (KR); Sun Dae KIM, Suwon-si (KR); Gi Hun JUNG, Suwon-si (KR); Jae Kwang KIM, Suwon-si (KR); Jin Ah SEO, Suwon-si (KR); Jin Hyeok LIM, Suwon-si (KR)

(73) Assignee: SAMSUNG SDI CO., LTD., Yongin-si (KR)

(21) Appl. No.: 19/408,629

(22) Filed: Dec. 4, 2025

(30) Foreign Application Priority Data
Dec. 5, 2024 (KR) 10-2024-0179205

(51) Int. Cl. H01M 10/0567; H01M 4/02; H01M 4/131; H01M 4/133; H01M 4/134; H01M 4/38; H01M 4/525; H01M 4/587; H01M 10/0525; H01M 10/0568; H01M 10/0569

(52) U.S. Cl. CPC H01M 10/0567; H01M 4/131; H01M 4/133; H01M 4/134; H01M 4/386; H01M 4/525; H01M 4/587; H01M 10/0525; H01M 10/0568; H01M 10/0569; H01M 2004/027; H01M 2004/028; H01M 2300/004

(57) ABSTRACT

The present disclosure relates to an electrolyte for a rechargeable lithium battery, and a rechargeable lithium battery including the electrolyte. The electrolyte includes a non-aqueous organic solvent, a lithium salt, and an additive.

### CROSS-REFERENCE TO RELATED APPLICATION

The present application claims priority to Korean Patent Application No. 10-2024-0179205, filed on Dec. 5, 2024 in the Korean Intellectual Property Office, the entire disclosure of which is incorporated herein by reference.

### FIELD OF THE DISCLOSURE

The present disclosure relates to an electrolyte for a rechargeable lithium battery, and a rechargeable lithium battery including the electrolyte.

### DESCRIPTION OF RELATED ART

With increasing presence of electronic devices using batteries such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery includes positive and negative electrodes that include active materials capable of intercalation and deintercalation of lithium ions, and an electrolyte, and produces electrical energy through oxidation and reduction reactions when the lithium ions are intercalated/deintercalated into/from the positive and negative electrodes.

As the electrolyte of such rechargeable lithium batteries, an electrolyte in which a lithium salt is dissolved in a non-aqueous organic solvent is used. Rechargeable lithium batteries exhibit battery characteristics through complex reactions between the positive electrode and the electrolyte, between the negative electrode and the electrolyte, and the like. Therefore, the use of a desired electrolyte is one of the relevant parameters in improving the performance of rechargeable lithium batteries.

### SUMMARY

One example embodiment includes an electrolyte for a rechargeable lithium battery which provides resistance reduction and gas generation reduction at high voltage and high temperature in the rechargeable lithium battery.

Another example embodiment includes a rechargeable lithium battery including the electrolyte.

One example embodiment includes an electrolyte for a rechargeable lithium battery, including a non-aqueous organic solvent, a lithium salt, and an additive, wherein the additive includes an additive of the following Chemical Formula 1:

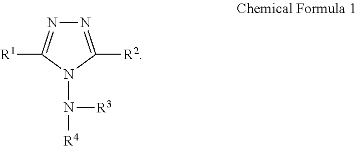

In Chemical Formula 1,
R¹, R², R³, and R⁴ are each as defined in the description of the disclosure below.

Another example embodiment includes a rechargeable lithium battery including a positive electrode including a positive electrode active material, a negative electrode including a negative electrode active material, and an electrolyte, wherein the electrolyte includes the electrolyte described above.

### BRIEF DESCRIPTION OF THE DRAWINGS

FIG. 1 is a conceptual diagram schematically showing a rechargeable lithium battery according to one example embodiment of the present disclosure.

FIG. 2 to FIG. 5 are cross-sectional views schematically showing rechargeable lithium batteries according to example embodiments.

### DETAILED DESCRIPTION OF THE DISCLOSURE

In order to fully understand the configurations and effects of the present disclosure, example embodiments of the present disclosure are described with reference to the accompanying drawings. However, it should be understood that the example embodiments disclosed below may be embodied in various forms and modified in various ways without being limited to the example embodiments described herein. However, the description of the present example embodiments is provided only to ensure that the disclosure of the present disclosure is made complete, and to fully inform a person having ordinary skill in the art to which the present disclosure belongs of the scope of the present disclosure.

In the present specification, when any component is referred to as being “on” another component, it means that the component may be formed directly on the other component, or a third component may be interposed therebetween. Also, in the drawings, the thicknesses of components may be exaggerated for the effective description of the technical contents. Throughout the present specification, parts denoted by the same reference numerals denote the same components.

Unless otherwise specified in the present specification, any feature indicated in the singular may also include the plural. In addition, unless otherwise particularly stated herein, “A or B” may mean “including A, including B, or including A and B.” As used in the present specification, the term “comprise” and/or “comprising” do not exclude the presence or addition of one or more other components.

In the present specification, the term “combination thereof” may refer to a mixture, laminate, composite, copolymer, alloy, blend, reaction product, and the like of components.

Unless otherwise defined in the present specification, the term “substituted” means that at least one hydrogen in a substituent or compound is replaced with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the term “substituted” may mean that at least one hydrogen in a substituent or compound is replaced with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may mean that at least one hydrogen in a substituent or compound is replaced with deuterium, a halogen group, a C1 to C20 alkyl group, a C6 to C30 aryl group, a C1 to C10 fluoroalkyl group, or a cyano group. Alternatively, the term “substituted” may mean that at least one hydrogen in the substituent or compound is replaced with deuterium, a halogen group, a C1 to C5 alkyl group, a C6 to C18 aryl group, a C1 to C5 fluoroalkyl group, or a cyano group. As an example, the term “substituted” may mean that at least one hydrogen in the substituent or compound is replaced with deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise particularly defined in the present specification, the symbol “*” refers to a moiety that is connected to the same or different atom or chemical formula. Unless specifically mentioned in the chemical formulas described in the present specification, it may be seen that hydrogen is bonded in the structure of the chemical formula.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

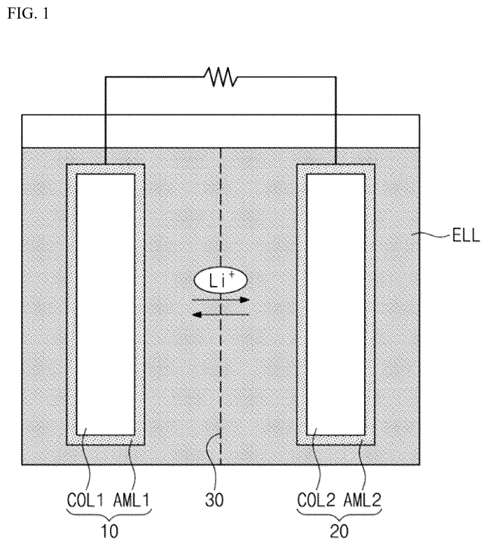

FIG. 1 is a conceptual diagram schematically showing a rechargeable lithium battery according to one example embodiment of the present disclosure. Referring to FIG. 1, the rechargeable lithium battery may include a positive electrode 10, a negative electrode 20, a separator 30, and an electrolyte (ELL).

The positive electrode 10 and the negative electrode 20 may be spaced apart from each other with the separator 30 interposed therebetween. The separator 30 may be disposed between the positive electrode 10 and the negative electrode 20. The positive electrode 10, the negative electrode 20 and the separator 30 may be in contact with the electrolyte (ELL). The positive electrode 10, the negative electrode 20 and the separator 30 may be impregnated with the electrolyte (ELL).

The electrolyte (ELL) may be or include a medium for transferring lithium ions between the positive electrode 10 and the negative electrode 20. In the electrolyte (ELL), the lithium ions may pass through the separator 30 to move toward the positive electrode 10 or the negative electrode 20.

### Positive Electrode 10

A positive electrode 10 for a rechargeable lithium battery may include a current collector (COL1) and a positive electrode active material layer (AML1) formed on the current collector (COL1). The positive electrode active material layer (AML1) includes a positive electrode active material, and may further include a binder and/or a conductive material.

As an example, the positive electrode 10 may further include an additive that may constitute a sacrificial positive electrode.

The content of the positive electrode active material in the positive electrode active material layer (AML1) may range from about 90% by weight to about 99.5% by weight based on 100% by weight of the positive electrode active material layer (AML1). The contents of the binder and conductive material may each range from about 0.5% by weight to about 5% by weight based on 100% by weight of the positive electrode active material layer (AML1).

The binder adheres positive electrode active material particles to each other, and adheres the positive electrode active material to the current collector (COL1). Representative examples of the binder include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but the present disclosure is not limited thereto.

The conductive material imparts conductivity to the electrodes, and any material may be used as long as the material is electronically conductive without causing adverse chemical changes in the battery to be formed. Examples of the conductive material include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

Al may be used as the current collector (COL1), but the present disclosure is not limited thereto.

### Positive Electrode Active Material

As the positive electrode active material in the positive electrode active material layer (AML1), a compound capable of reversible intercalation and deintercalation of lithium (lithiated intercalation compound) may be used. For example, at least one of a composite oxide of lithium and a metal such as or including at least one of cobalt, manganese, nickel, and a combination thereof may be used.

The composite oxide may be or include a lithium transition metal composite oxide, and examples thereof include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b<0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof, and L¹ is or includes at least one of Mn, Al, or a combination thereof.

As an example, the positive electrode active material may be or include a high-nickel positive electrode active material in which the content of nickel is about 80 mol % or more, about 85 mol % or more, about 90 mol % or more, about 91 mol % or more, or about 94 mol % or more, and about 99 mol % or less, based on 100 mol % of metals excluding lithium in the lithium transition metal composite oxide. The high-nickel positive electrode active material may achieve high capacity, and thus may be applied to high-capacity, high-density rechargeable lithium batteries.

### Negative Electrode 20

A negative electrode 20 for a rechargeable lithium battery includes a current collector (COL2) and a negative electrode active material layer (AML2) disposed on the current collector (COL2). The negative electrode active material layer (AML2) includes a negative electrode active material, and may further include a binder and/or a conductive material.

For example, the negative electrode active material layer (AML2) may include a range of about 90% by weight to about 99% by weight of the negative electrode active material, a range of about 0.5% by weight to about 5% by weight of the binder, and a range of about 0% by weight to about 5% by weight of the conductive material.

The binder adheres negative electrode active material particles to each other, and adheres the negative electrode active material to the current collector (COL2). A non-aqueous binder, an aqueous binder, a dry binder, or a combination thereof may be used as the binder.

The non-aqueous binder includes at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, one or more types of carboxymethyl cellulose, hydroxypropylmethyl cellulose, methyl cellulose, or alkali metal salts thereof may be mixed and used. At least one of Na, K or Li may be used as the alkali metal.

The dry binder is or includes a fiberizable polymeric material, and may be or include, for example, at least one of polytetrafluoroethylene, polyvinylidene fluoride, a polyvinylidene fluoride-hexafluoropropylene copolymer, polyethylene oxide, or a combination thereof.

The conductive material imparts conductivity to the electrodes, and any material may be used as long as the material is electronically conductive without causing adverse chemical changes in the battery to be formed. Examples include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

A current collector such as or including at least one of copper foil, nickel foil, stainless steel foil, titanium foil, a nickel foam, a copper foam, a polymer substrate coated with a conductive metal, and a combination thereof may be used as the current collector (COL2).

### Negative Electrode Active Material

The negative electrode active material in the negative electrode active material layer (AML2) includes at least one of a material capable of reversible intercalation/deintercalation of lithium ions, a lithium metal, an alloy of lithium and a metal, a material capable of doping and dedoping lithium, or a transition metal oxide.

The material capable of reversible intercalation/deintercalation of lithium ions may include a carbon-based negative electrode active material, for example, crystalline carbon, amorphous carbon, or a combination thereof. Examples of the crystalline carbon include graphite such as amorphous, plate-like, flaky, spherical, or fibrous natural or artificial graphite, and examples of the amorphous carbon include at least one of soft carbon or hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be or include at least one of silicon, a silicon-carbon composite, SiOₓ (0<x<2), a Si-Q alloy (wherein Q is or includes at least one of an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles which surfaces are coated with amorphous carbon. For example, the silicon-carbon composite may include a secondary particle (core) in which silicon primary particles are assembled, and an amorphous carbon coating layer (shell) disposed on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer disposed on the surface of the core.

The Si-based negative electrode active material or the Sn-based negative electrode active material may be used in combination with a carbon-based negative electrode active material.

### Separator 30

A separator 30 may be present between the positive electrode 10 and the negative electrode 20 depending on the type of rechargeable lithium battery. As the separator 30, polyethylene, polypropylene, polyvinylidene fluoride, or a multi-layer film of two or more layers thereof may be used. A mixed multi-layer film such as or including at least one of a polyethylene/polypropylene two-layer separator, a polyethylene/polypropylene/polyethylene three-layer separator, a polypropylene/polyethylene/polypropylene three-layer separator, and the like may also be used.

The separator 30 may include a porous substrate and a coating layer including an organic material, an inorganic material, or a combination thereof and disposed on one surface, or on both surfaces, of the porous substrate.

The porous substrate may be or include a polymer film formed of or including any one polymer such as or including at least one of polyolefins such as polyethylene, polypropylene, and the like, polyesters such as polyethylene terephthalate, polybutylene terephthalate, polyethylene naphthalate and the like, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fibers, Teflon, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be present as a mixture in one coating layer, or may be present in the form in which a coating layer including an organic material and a coating layer including an inorganic material are laminated.

### Electrolyte (ELL)

An electrolyte (ELL) for a rechargeable lithium battery includes a non-aqueous organic solvent and a lithium salt.

The non-aqueous organic solvent constitutes a medium through which ions involved in the electrochemical reaction of the battery may move.

The non-aqueous organic solvent may be or include at least one of a carbonate-based, ester-based, ether-based, ketone-based, or alcohol-based solvent, an aprotic solvent, or a combination thereof.

As the carbonate-based solvent, at least one of dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and the like may be used.

As the ester-based solvent, at least one of methyl acetate, ethyl acetate, n-propyl acetate, dimethyl acetate, methyl propionate, ethyl propionate, decanolide, mevalonolactone, valerolactone, caprolactone, and the like may be used.

As the ether-based solvent, at least one of dibutyl ether, tetraglyme, diglyme, dimethoxyethane, 2-methyltetrahydrofuran, 2,5-dimethyltetrahydrofuran, tetrahydrofuran, and the like may be used. Also, cyclohexanone and the like may be used as the ketone-based solvent. Ethyl alcohol, isopropyl alcohol, and the like may be used as the alcohol-based solvent. As the aprotic solvent, at least one of nitriles such as R—CN (where R is a linear, branched, or cyclic hydrocarbon group having 2 to 20 carbon atoms and may include a double bond, an aromatic ring, or an ether group) and the like; amides such as dimethylformamide and the like; dioxolanes such as 1,3-dioxolane, 1,4-dioxolane, and the like; and sulfolanes, may be used.

The non-aqueous organic solvents may be used alone, or in combination of two or more solvents.

When the carbonate-based solvent is used, a cyclic carbonate and a chain carbonate may be used in combination, and the cyclic carbonate and the chain carbonate may be mixed in a volume ratio in a range of about 1:1 to about 1:9.

The lithium salt dissolves in a non-aqueous organic solvent and thus constitutes a source of lithium ions in the battery, thereby allowing the basic operation of a rechargeable lithium battery, and promotes the movement of lithium ions between the positive and negative electrodes. Representative examples of the lithium salt may include at least one or more of LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (where x and y are integers ranging from 1 to 20), lithium trifluoromethane sulfonate, lithium tetrafluoroethanesulfonate, lithium difluorobis(oxalato) borate (LiDFOB), lithium difluorobis(oxalato)phosphate (LiDFBOP), and lithium bis(oxalato) borate (LiBOB), Lithium bis(trifluoromethanesulphonyl)imide (LiTFSI) and Lithium tetrafluoro(oxalato)phosphate (LiTFOP).

### Rechargeable Lithium Battery

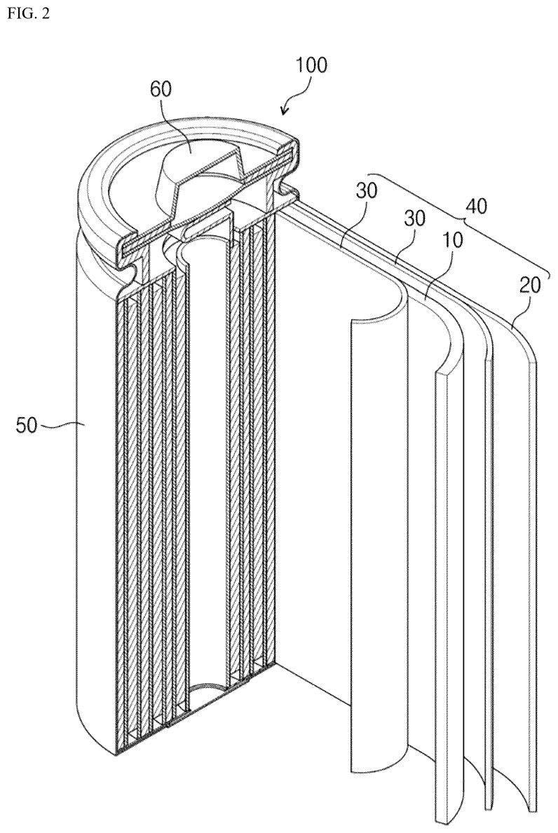

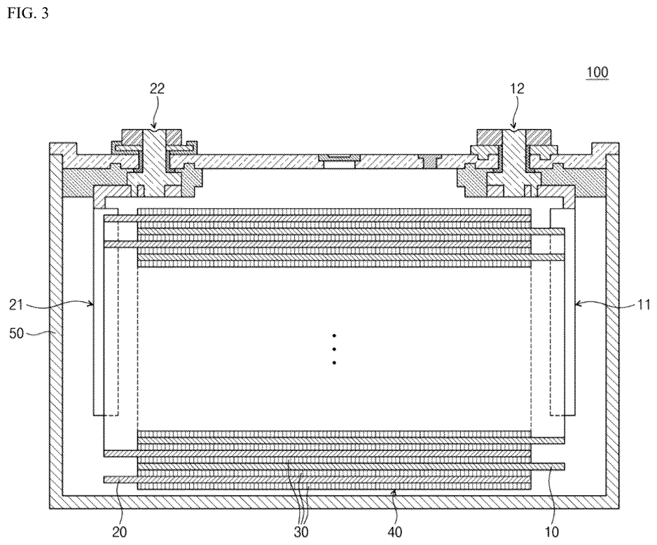

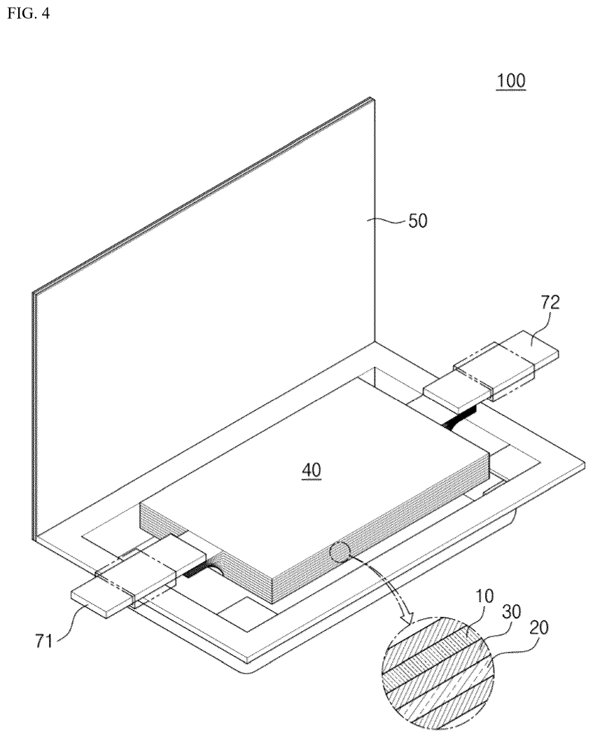

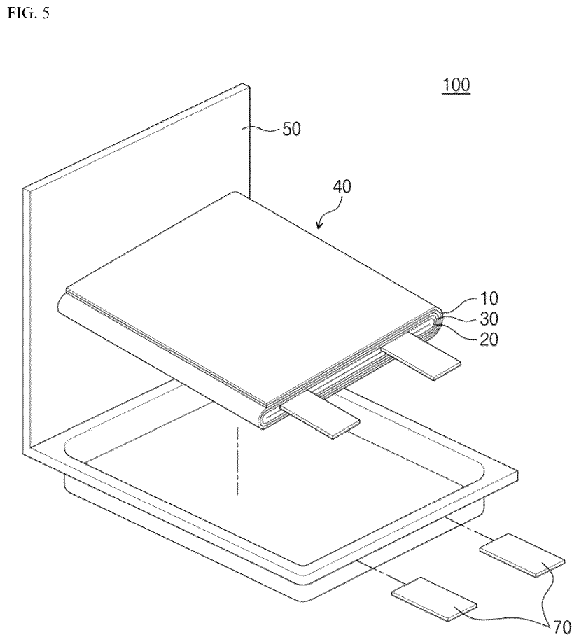

Rechargeable lithium batteries may be classified into cylindrical, prismatic, pouch-type, and coin-type rechargeable lithium batteries depending on the type of rechargeable lithium battery. FIG. 2 to FIG. 5 are diagrams schematically showing rechargeable lithium batteries according to example embodiments. The rechargeable lithium batteries can be said to be cylindrical, prismatic, and pouch-type batteries, as shown in FIG. 2, FIG. 3, and FIG. 4 and FIG. 5, respectively. Referring to FIG. 2 to FIG. 5, a rechargeable lithium battery 100 may include an electrode assembly 40 having a separator 30 interposed between a positive electrode 10 and a negative electrode 20, and a case 50 in which the electrode assembly 40 is built. The positive electrode 10, the negative electrode 20, and the separator 30 may be impregnated with an electrolyte (not shown). The rechargeable lithium battery 100 may include a sealing member 60 configured to seal the case 50 as shown in FIG. 2. Also, as shown in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include electrode tabs 70 illustrated in FIG. 5, or a positive electrode tab 71 and a negative electrode tab 72 illustrated in FIG. 4, the electrode tabs 70/71/72 forming electric paths configured to conduct current formed in the electrode assembly 40 to the outside of the battery 100.

Hereinafter, the electrolyte of a rechargeable lithium battery according to one example embodiment of the present disclosure is described in more detail.

An electrolyte for a rechargeable lithium battery according to one example embodiment includes the above-described non-aqueous organic solvent, a lithium salt, and an additive, wherein the additive includes an additive of Chemical Formula 1 described below.

The electrolyte may be prepared by a method of dissolving the lithium salt in the non-aqueous organic solvent, adding an additive of Chemical Formula 1, and then mixing the lithium salt and the additive. A process of mixing electrolytes is widely known in the field of electrolyte preparation, and those skilled in the art are able to select and use the mixing process as desired.

The non-aqueous organic solvent according to one example embodiment of the present disclosure may include one or more of the non-aqueous organic solvents described above.

In one example embodiment, the non-aqueous organic solvent may be or include a mixture including ethylene carbonate (EC):ethyl methyl carbonate (EMC):dimethyl carbonate (DMC) in a volume ratio in a range of about 10 to 40:10 to 40:40 to 80 or 10 to 30:10 to 30:40 to 80. Here, a volume ratio is based on 100% by volume of the sum of ethylene carbonate (EC), ethyl methyl carbonate (EMC), and dimethyl carbonate (DMC). In the above range, it is possible to implement the effect of the additive described below, and the lifespan of the battery can be further improved under high voltage and high temperature conditions in a rechargeable lithium battery including a positive electrode active material having a high nickel content described below.

According to one example embodiment of the present disclosure, the lithium salt may include at least one or more of LiPF₆, LiClO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LIN(SO₃C₂F₅)₂, Li(FSO₂)₂N, and LiC₄F₉SO₃. In one example embodiment, LiPF₆ may be used as the lithium salt.

A concentration of the lithium salt may range from about 0.1 M to about 3.0 M. For example, the concentration of the lithium salt may be in a range of about 0.5 M or more or about 1.0 M or more. The concentration of the lithium salt may be in a range of about 3.0 M or less, about 2.5 M or less, or about 2.0 M or less. In the present disclosure, when the concentration of the lithium salt is in a range of about 0.1 M to about 2.0 M, the conductivity and viscosity of the electrolyte can be maintained as desired.

### Additive

An additive according to one example embodiment of the present disclosure includes an additive of Chemical Formula 1 described below.

The additive of Chemical Formula 1 can provide the effect of reducing gas generation and resistance in the battery under high voltage and high temperature conditions by being included in the electrolyte of a rechargeable lithium battery. In particular, the additives can improve the lifespan and safety of a battery by significantly improving the gas generation reduction and resistance reduction effect in a battery including a positive electrode active material having a significantly high nickel content. A battery including the positive electrode active material with a significantly high nickel content has high energy density, but may have a deterioration in battery performance due to gas generation and increased resistance when stored at high voltage and high temperature. Here, “high voltage” means about 4.4 V or higher.

The additive of Chemical Formula 1 is represented by Chemical Formula 1 below. The electrolyte may include one or more additives of the following Chemical Formula 1:

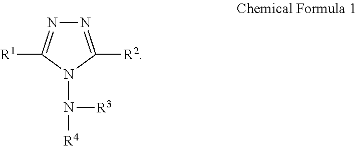

In Chemical Formula 1,
R¹ and R² each independently is or includes hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
R³ and R⁴ each independently is or includes hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group; or represented by the following Chemical Formula 1-1,
at least one of R³ and R⁴ is represented by the following Chemical Formula 1-1:

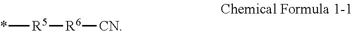

In Chemical Formula 1-1,
R⁵ and R⁶ each independently is or includes a single bond, a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

In one example embodiment, both R³ and R⁴ in Chemical Formula 1 may be the same as in Chemical Formula 1-1. In this case, the additive of Chemical Formula 1 may have a desired or improved effect of improving the lifespan of the battery at high voltage and high temperature when applied to a battery including a positive electrode active material having a high nickel content.

In one example embodiment, in Chemical Formula 1-1, R⁵ and R⁶ may each be or include independently a substituted or unsubstituted C1 to C20 alkylene group, for example, a substituted or unsubstituted C1 to C10 alkylene group, or a substituted or unsubstituted C1 to C5 alkylene group, for example, methylene, ethylene, a linear or branched propylene group, a linear or branched butylene group, or a linear or branched pentylene group. In this case, the additive of Chemical Formula 1 may have a desired or improved effect of improving the lifespan of the battery at high voltage and high temperature when applied to a battery including a positive electrode active material having a high nickel content.

R¹ and R² may each be or include independently hydrogen, a substituted or unsubstituted C1 to C20 alkyl group, for example, a substituted or unsubstituted C1 to C10 alkyl group, a substituted or unsubstituted C1 to C5 alkyl group, for example, hydrogen, methyl, ethyl, a linear or branched propyl group, a linear or branched butyl group, or linear or branched pentyl group. In this case, the additive of Chemical Formula 1 may have a desired or improved effect of improving the lifespan of the battery at high voltage and high temperature when applied to a battery including a positive electrode active material having a high nickel content.

According to another example embodiment of the present disclosure, the additive of Chemical Formula 1 may be one or more additives of Chemical Formula 1-3 below:

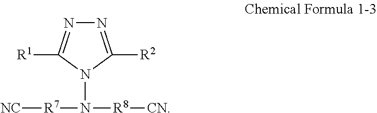

In Chemical Formula 1-3,
R¹ and R² each independently is or includes the same as defined in Chemical Formula 1, and
R⁷ and R⁸ each independently is or includes a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

In one example embodiment, in Chemical Formula 1-3, R⁷ and R⁸ may each be or include independently a substituted or unsubstituted C1 to C20 alkylene group, for example, a substituted or unsubstituted C1 to C10 alkylene group, or a substituted or unsubstituted C1 to C5 alkylene group, for example, methylene, ethylene, a linear or branched propylene group, a linear or branched butylene group, or a linear or branched pentylene group. In this case, the additive of Chemical Formula 1 may have a desired or improved effect of improving the lifespan of the battery at high voltage and high temperature when applied to a battery including a positive electrode active material having a high nickel content.

In one example embodiment, the additive of Chemical Formula 1 may include one or more of the following Chemical Formulas 1-4 to 1-10:

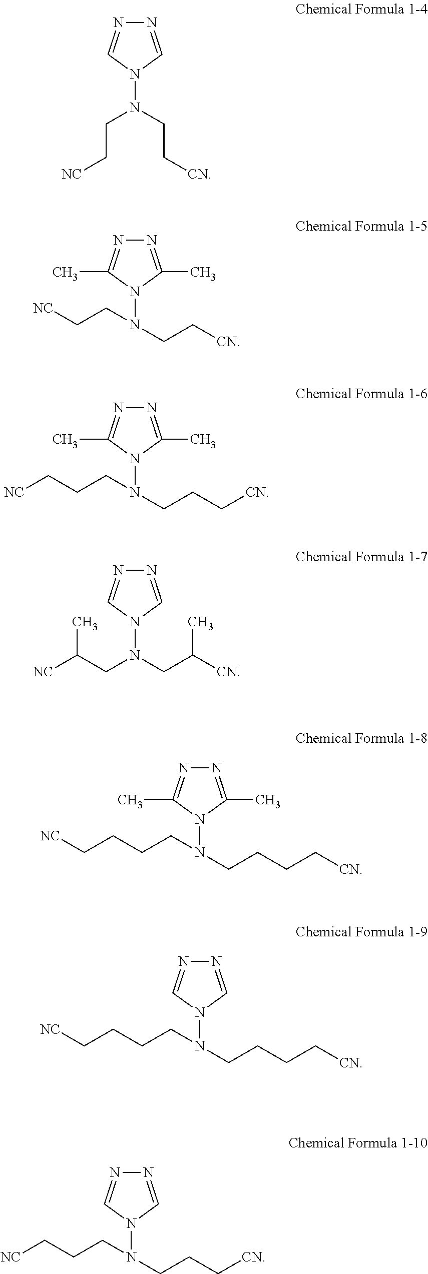

The additive of Chemical Formula 1 and the additive of Chemical Formula 1-3 may each be synthesized through a conventional synthetic method known to those skilled in the art. For example, the additive may be prepared using a compound providing 4H-1,2,4-triazole and a CN group.

The additive of Chemical Formula 1 may be included in an amount in a range of about 0.05 wt % to about 5 wt % based on the total amount of the electrolyte. In the above range, the effect of the above-described mixture can be implemented. For example, the additive of Chemical Formula 1 may be included in an amount in a range of about 0.1 wt % to about 5 wt %, 0.05 wt % to 5 wt %, or 0.5 wt % to 5 wt % based on the total amount of the electrolyte. When the content of the additive is within the above range, the effect of the mixture is significantly increased, and there may be an additional effect of not increasing the resistance of the battery.

In one example embodiment, the additive of Chemical Formula 1 may be included in an amount of about 95 wt % or more, for example, in a range of about 95 wt % to about 100 wt %, 99 wt % to 100 wt %, or 100 wt % of the total additives in the electrolyte. In the above range, the processability of the battery can be improved with the implementation of the battery effect even without the additional additives described above.

As a result, the electrolyte according to the present disclosure, by including the additive in the combination of the non-aqueous organic solvent and lithium salt, simultaneously or contemporaneously generates the effects of reducing a resistance increase and gas generation during high-temperature storage in a rechargeable lithium battery including a positive electrode active material, particularly a positive electrode active material having a high nickel content, thereby enabling implementation of a rechargeable lithium battery with improved lifespan characteristics and stability.

In another example embodiment of the present disclosure, a rechargeable lithium battery including a positive electrode including a positive electrode active material, a negative electrode including a negative electrode active material, and an electrolyte can be provided, wherein the electrolyte includes a non-aqueous organic solvent, a lithium salt, and an additive, and the additive includes an additive of Chemical Formula 1.

The rechargeable lithium battery may be applicable to, e.g., vehicles, mobile phones, and/or various types of electrical devices, but the present disclosure is not limited thereto.

The positive electrode active material may be or include a lithium transition metal composite oxide, and examples thereof may include at least one of lithium nickel-based oxides, lithium cobalt-based oxides, lithium manganese-based oxides, lithium iron phosphate-based compounds, cobalt-free nickel manganese-based oxides, or a combination thereof.

As an example, a compound represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may include, for example, at least one of a lithium nickel-based oxide represented by the following Chemical Formula 2, a lithium cobalt-based oxide represented by the following Chemical Formula 3, a lithium iron phosphate-based compound represented by the following Chemical Formula 4, a cobalt-free lithium nickel manganese-based oxide represented by the following Chemical Formula 5, or a combination thereof.

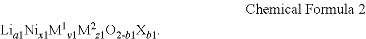

In Chemical Formula 2, 0.9≤a1≤1.8, 0.3≤x1≤1, 0≤y1≤0.7, 0≤z1≤0.7, 0.9≤x1+y1+z1≤1.1, and 0≤b1≤0.1, and M¹ and M² each independently is or includes at least one or more of Al, B, Ba, Ca, Ce, Co, Cr, Cu, Fe, Mg, Mn, Mo, Nb, Si, Sn, Sr, Ti, V, W, and Zr, and X is or includes at least one or more of F, P, and S.

In Chemical Formula 2, 0.6≤x1≤1, 0≤y1≤0.4, and 0≤z1≤0.4, or 0.8≤x1≤1, 0≤y1≤0.2, and 0≤z1≤0.2.

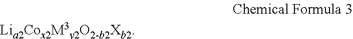

In Chemical Formula 3, 0.9≤a2≤1.8, 0.7≤x2≤1, 0≤y2≤0.3, 0.9≤x2+y2≤1.1, and 0≤b2≤0.1, M³ is or includes at least one or more of Al, B, Ba, Ca, Ce, Cr, Cu, Fe, Mg, Mn, Mo, Ni, Se, Si, Sn, Sr, Ti, V, W, Y, Zn, and Zr, and X is or includes at least one or more of F, P, and S.

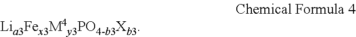

In Chemical Formula 4, 0.9≤a3≤1.8, 0.6≤x3≤1, 0≤y3≤0.4, and 0≤b3≤0.1, M⁴ is or includes at least one or more of Al, B, Ba, Ca, Ce, Co, Cr, Cu, Mg, Mn, Mo, Ni, Se, Si, Sn, Sr, Ti, V, W, Y, Zn, and Zr, and X is or includes at least one or more of F, P, and S.

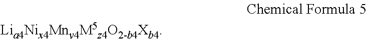

In Chemical Formula 5, 0.95a4≤1.8, 0.8≤x4<1, 0<y4<0.2, 0≤z4≤0.2, 0.95≤x4+y4+z4≤1.1, and 0≤b4≤0.1, and M⁵ is or includes at least one or more of Al, B, Ba, Ca, Ce, Cr, Fe, Mg, Mo, Nb, Si, Sn, Sr, Ti, V, W, and Zr, and X is or includes at least one or more of F, P, and S.

For example, the positive electrode active material may be or include a high-nickel positive electrode active material in which a nickel content is about 80 mol % or more, about 85 mol % or more, about 90 mol % or more, about 91 mol % or more, or about 94 mol % or more and about 99 mol % or less, based on 100 mol % of metals other than lithium in a lithium transition metal composite oxide. The high-nickel positive electrode active material can achieve high capacity, and thus can be applied to high-capacity, high-density rechargeable lithium batteries.

In an example embodiment, the negative electrode active material may include at least one of graphite and a Si composite.

When the negative electrode active material includes both the Si composite and graphite, the Si composite and graphite may be included in the form of a mixture, and in this case, the Si composite and graphite may be included in a weight ratio in a range of about 1:99 to about 50:50 based on a total of 100 parts by weight. For example, the Si composite and graphite may be included in a weight ratio in a range of about 3:97 to about 20:80, in a range of about 4:96 to about 20:80, or in a range of about 5:95 to about 20:80.

The Si composite includes a core including Si-based particles and an amorphous carbon coating layer, and for example, the Si-based particles may include one or more of a Si—C composite, SiOₓ (0<x≤2), and a Si alloy. For example, the Si—C composite may include a core including Si particles and crystalline carbon, and an amorphous carbon coating layer located on the surface of the core. The crystalline carbon may include, for example, graphite, and for example, natural graphite, artificial graphite or a mixture thereof.

When the positive electrode includes the high-nickel positive electrode active material and the negative electrode includes graphite, the effect of improving the high-temperature stability of the rechargeable lithium battery may be maximized.

Hereinafter, examples and comparative examples of the present disclosure are described. However, the following examples are only examples of the present disclosure, and the present disclosure is not limited to the following examples.

### Synthesis Example 1

8 g of NaOH was input to a round bottom flask, and then 50 g of distilled water was input and stirred for 30 minutes at room temperature (23±2° C.).

8.41 g of 4-amino-1,2,4-triazole was input thereto, additionally stirred for 30 minutes, and then the temperature inside the reaction mixture was maintained at no more than 40° C. while slowly adding 13.3 g of acrylonitrile to the reaction mixture dropwise.

When a white solid was produced, the white solid was filtered through a filter, washed with water and ethanol, and then vacuum dried to obtain a compound represented by the following Chemical Formula 1-4.

(400 MHz, DMSO-d₆): δ 8.74 (s, 2H), 3.40-3.37 (m, 4H), 2.53-2.49 (m, 4H)

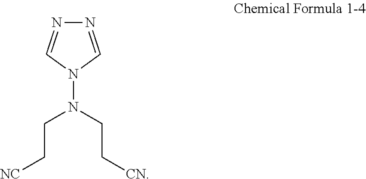 [SMILES: N#CCCN(CCC#N)n1cnnc1]

### Synthesis Example 2

A compound represented by the following Chemical Formula 1-5 was obtained by performing the same procedure as in Synthesis Example 1, except that 4-amino-3,5-dimethyl-4H-1,2,4-triazole was used instead of 4-amino-1,2,4-triazole.

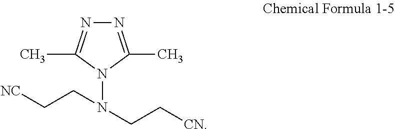 [SMILES: Cc1nnc(C)n1N(CCC#N)CCC#N]

### Synthesis Example 3

A compound represented by the following Chemical Formula 1-6 was obtained by performing the same procedure as in Synthesis Example 1, except that 4-amino-3,5-dimethyl-4H-1,2,4-triazole was used instead of 4-amino-1,2,4-triazole and allyl cyanide was used instead of acrylonitrile.

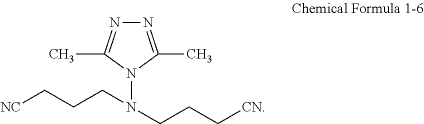 [SMILES: Cc1nnc(C)n1N(CCCC#N)CCCC#N]

### EXAMPLES AND COMPARATIVE EXAMPLES

### Example 1

### (1) Preparation of Electrolyte

1.25 M LiPF₆ was dissolved in a carbonate-based solvent including ethylene carbonate:ethyl methyl carbonate:dimethyl carbonate in a respective volume ratio of 20:30:50 based on a total volume of 100%, and the additive of Chemical Formula 1-4 was added and mixed to prepare an electrolyte.

### (2) Manufacture of Rechargeable Lithium Battery

97 wt % of LiNi_{0.91}Co_{0.08}Al_{0.01}O₂ as a positive electrode active material, 0.5 wt % of artificial graphite powder as a conductive material, 1 wt % of carbon black (Ketjen black), and 1.5 wt % of polyvinylidene fluoride (PVdF) were mixed, input into an N-methyl-2-pyrrolidone (NMP), and stirred for 30 minutes using a mechanical stirrer to prepare a positive electrode active material slurry. The slurry was applied to a thickness of about 60 μm onto a 20 μm-thick aluminum current collector using a doctor blade, dried in a hot air dryer at 100° C. for 0.5 hour, dried again under vacuum at 120° C. for 4 hours, and then roll-pressed to manufacture a positive electrode.

98 wt % of a negative electrode active material, which is a mixture of graphite and Si composite in a weight ratio of 95.8:4.2, 1 wt % of a styrene-butadiene rubber (SBR), and 1 wt % of carboxymethyl cellulose (CMC) were mixed, and then the mixture was input into distilled water and stirred for 60 minutes using a mechanical stirrer to prepare a negative electrode active material slurry. The slurry was applied to a thickness of about 60 μm onto a 10 μm-thick copper current collector using a doctor blade, dried in a hot air dryer at 100° C. for 0.5 hour, dried again under vacuum at 120° C. for 4 hours, and then roll-pressed to manufacture a negative electrode.

The positive electrode, the negative electrode and a separator made of a polyethylene material and having a thickness of 16 μm were assembled to manufacture an electrode assembly, and the electrolyte was injected to manufacture a cylindrical rechargeable lithium battery.

### Examples 2 to 4

An electrolyte and a battery were manufactured in the same manner as in Example 1, except that the content of the additive of Chemical Formula 1-4 in Example 1 was changed as shown in Table 1 below.

### Example 5

An electrolyte and a battery were manufactured in the same manner as in Example 2, using the additive of Chemical Formula 1-5 instead of the additive of Chemical Formula 1-4.

### Example 6

An electrolyte and a battery were manufactured in the same manner as in Example 2, using the additive of Chemical Formula 1-6 instead of the additive of Chemical Formula 1-4.

### Comparative Example 1

An electrolyte and a battery were manufactured in the same manner as in Example 1, except that the additive of Chemical Formula 1-4 was not used in Example 1.

### EVALUATION EXAMPLES

Rechargeable lithium batteries were evaluated using the following methods.

### Evaluation Example 1: Evaluation of High Temperature Storage Characteristics—Cell Thickness Increase Rate

High-temperature gas generation characteristics were evaluated by measuring the cell thickness increase rate for the rechargeable lithium batteries according to examples and comparative examples. The initial thickness of the cell battery and the thickness of the cell battery after storage at 60° C. for 28 days were measured, and the thickness increase rate was calculated, and the results are shown in Table 1 below. The thickness increase rate was calculated according to the following Equation.

Thickness increase rate (%)=[Thickness of cell battery after 28 days of storage at 60° C./Initial thickness of cell battery]*100. Equation:

For example, the thickness of the cell battery was measured using a compression thickness gauge from Mitutoyo, by placing the pouch cell between compression plates and compressing the pouch with a weight of 300 g.

### Evaluation Example 2: Evaluation of High Temperature Storage Characteristics—OCV Retention Rate

For the rechargeable lithium batteries according to examples and comparative examples, 0.5 C/4.4V 0.05 C cut-off charging was performed, and then the batteries were stored at 60° C. for 28 days. The OCV was measured, and delta OCV (ΔOCV) was calculated therefrom, and the results are shown in Table 1 below. A smaller ΔOCV value means a better capacity retention rate.

### Evaluation Example 3: Evaluation of High Temperature Storage Characteristics—DCIR Increase Rate

For the rechargeable lithium batteries according to examples and comparative examples, the initial direct current internal resistance (DCIR) was measured as the ΔV/ΔI (voltage change/current change) value, and then the maximum energy state inside the battery was made into a fully charged state (SOC 100%), and in this state, the battery was stored at a high temperature (60° C.) for 60 days, after which the DCIR was measured, and the DCIR increase rate (%) was calculated according to the following Equation, and the results are shown in Table 2 below.

$$DCIR increase rate ( \% ) = ( DCIR after 60 days / Initial DCIR ) * 100. \qquad Equation$$

The results of the above Evaluation Examples 1 to 3 are shown in Table 1 below.

TABLE 1

| | | | Cell battery thickness | | |
|---|---|---|---|---|---|
| | Additive | | Day 0 | Day 28 | Increase |
| | Type | Content | (cm) | (cm) | rate (%) |
| Example 1 | Chemical | 0.5 | 10.30 | 14.81 | 143.8 |
| | Formula 1-4 | | | | |
| Example 2 | Chemical | 1 | 10.30 | 14.69 | 142.6 |
| | Formula 1-4 | | | | |
| Example 3 | Chemical | 2 | 10.31 | 14.27 | 138.4 |
| | Formula 1-4 | | | | |
| Example 4 | Chemical | 5 | 10.32 | 13.75 | 133.2 |
| | Formula 1-4 | | | | |
| Example 5 | Chemical | 1 | 10.30 | 14.70 | 142.7 |
| | Formula 1-5 | | | | |
| Example 6 | Chemical | 1 | 10.31 | 14.71 | 142.7 |
| | Formula 1-6 | | | | |
| Comparative | — | — | 10.29 | 15.12 | 146.9 |
| Example 1 | | | | | |

| | | | DCIR | | |
|---|---|---|---|---|---|
| | OCV(V) | | Day 0 | Day 60 | Increase |
| | Day 0 | Day 28 | (mΩ) | (mΩ) | rate (%) |
| Example 1 | 4.23 | 4.10 | 8.83 | 10.76 | 121.9 |
| Example 2 | 4.23 | 4.10 | 8.91 | 10.91 | 122.4 |
| Example 3 | 4.23 | 4.12 | 9.12 | 11.22 | 123.0 |
| Example 4 | 4.23 | 4.13 | 9.55 | 11.80 | 123.6 |
| Example 5 | 4.23 | 4.10 | 8.91 | 10.95 | 122.9 |
| Example 6 | 4.23 | 4.10 | 8.92 | 10.97 | 123.0 |
| Comparative | 4.23 | 4.07 | 8.52 | 10.56 | 123.9 |
| Example 1 | | | | | |

### CONCLUSION

Referring to Table 1 above, it can be concluded that the electrolytes of the Examples can improve high-voltage lifespan and high-temperature performance in a rechargeable lithium battery including a high-nickel positive electrode active material based on the results of Evaluation Examples 1 to 3.

However, referring to Table 1 above, Comparative Example 1, which does not include the additive of Chemical Formula 1 of the present disclosure, has a relatively high gas generation amount according to the results of Evaluation Examples 1 to 3, and thus, compared to the Examples, the cell thickness increase rate is high in a rechargeable lithium battery including a high-nickel positive electrode active material, so the gas generation amount is high, the OCV decrease is high, and the DCIR increase rate is also high, and it can be expected that there is a significant lack of improvement in high-voltage lifespan and high-temperature performance.

An electrolyte according to one example embodiment can exhibit an effect of improving the lifespan characteristics and stability under high voltage and high temperature conditions during rechargeable lithium battery activation in the rechargeable lithium battery.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. An electrolyte for a rechargeable lithium battery, the electrolyte comprising:
a non-aqueous organic solvent;
a lithium salt; and
an additive,
wherein the additive includes an additive of the following Chemical Formula 1: 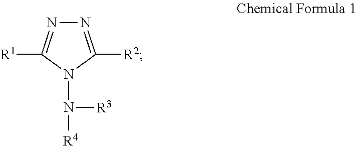
in Chemical Formula 1,
R¹ and R² each independently comprises hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
R³ and R⁴ each independently comprises hydrogen, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group; or is represented by the following Chemical Formula 1-1,
at least one of R³ and R⁴ is represented by the following Chemical Formula 1-1: 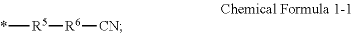
in Chemical Formula 1-1,
R⁵ and R⁶ each independently comprises a single bond, a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

2. The electrolyte of claim 1, wherein the additive of Chemical Formula 1 is represented by the following Chemical Formula 1-3: 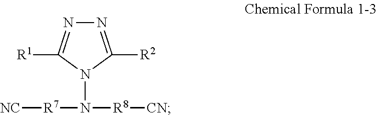
in Chemical Formula 1-3,
R¹ and R² are each independently the same as in Chemical Formula 1, and
R⁷ and R⁸ each independently comprises a substituted or unsubstituted C1 to C20 alkylene group, a substituted or unsubstituted C1 to C20 alkoxylene group, a substituted or unsubstituted C2 to C20 alkenylene group, a substituted or unsubstituted C2 to C20 alkynylene group, a substituted or unsubstituted C3 to C20 cycloalkylene group, a substituted or unsubstituted C6 to C20 arylene group, or a substituted or unsubstituted C2 to C20 heteroarylene group.

3. The electrolyte of claim 1, wherein the additive of Chemical Formula 1 comprises one or more of the following Chemical Formulas 1-4 to 1-10:

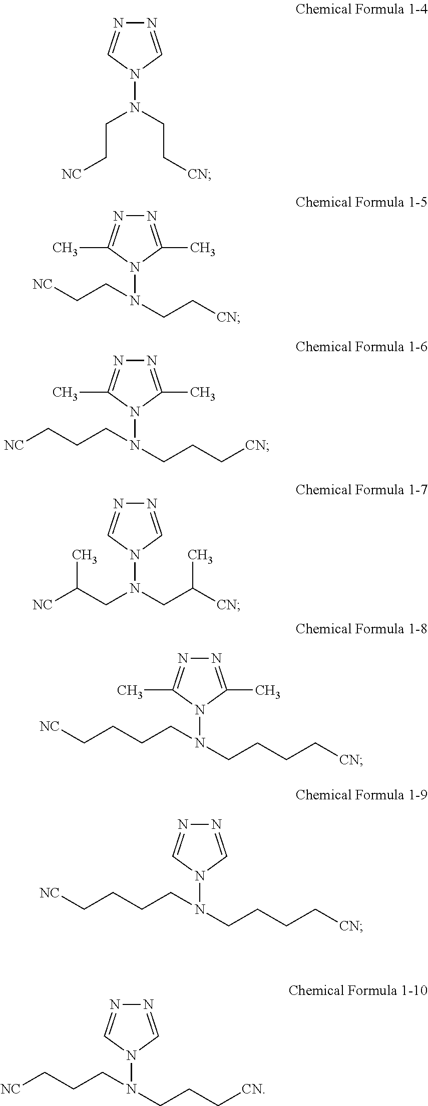

4. The electrolyte of claim 1, wherein the additive of Chemical Formula 1 is included in an amount in a range of about 0.05 wt % to about 5 wt % based on the total amount of the electrolyte.

5. The electrolyte of claim 1, wherein the additive of Chemical Formula 1 is included in an amount of about 95 wt % or more of the total additives of the electrolyte.

6. The electrolyte of claim 1, wherein the non-aqueous organic solvent comprises a mixture including ethylene carbonate (EC):ethyl methyl carbonate (EMC):dimethyl carbonate (DMC) in a volume ratio in a range of about 10 to 40:10 to 40:40 to 80.

7. The electrolyte of claim 1, wherein the lithium salt comprises one or more of LiPF₆, LiClO₄, LiBF₄, lithium bis(fluorosulfonyl)imide (LiFSI), LiTFSI, LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C2F₅)₂, Li(FSO₂)₂N, and LiC₄F₉SO₃.

8. The electrolyte of claim 1, wherein a concentration of the lithium salt is in a range of about 0.1 M to about 2.0 M.

9. A rechargeable lithium battery comprising:
a positive electrode including a positive electrode active material;
a negative electrode including a negative electrode active material; and
the electrolyte according to claim 1.

10. The rechargeable lithium battery of claim 9, wherein the positive electrode active material comprises a lithium transition metal composite oxide having a nickel content of about 80 mol % or more based on 100 mol % of metals other than lithium.

11. The rechargeable lithium battery of claim 9, wherein the lithium transition metal composite oxide comprises a lithium composite oxide represented by the following Chemical Formula 2: 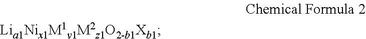
wherein:
0.9≤a1≤1.8, 0.3≤x1≤1, 0≤y1≤0.7, 0≤z1≤0.7, 0.9≤x1+y1+z1≤1.1, and 0=b1≤0.1, and
M¹ and M² each independently comprises one or more of Al, B, Ba, Ca, Ce, Co, Cr, Cu, Fe, Mg, Mn, Mo, Nb, Si, Sn, Sr, Ti, V, W, and Zr, and
X comprises one or more of F, P, and S.

12. The rechargeable lithium battery of claim 11, wherein in Chemical Formula 2, 0.8≤x1≤1, 0≤y1≤0.2, and 0≤z1≤0.2.

13. The rechargeable lithium battery of claim 9, wherein the negative electrode active material comprises at least one of graphite and a Si composite.

14. The rechargeable lithium battery of claim 9, wherein the rechargeable lithium battery is a cylindrical, prismatic, pouch-shaped, or coin-shaped battery.
